(19) United States
(12) Patent Application Publication
(10) Pub. No.: US 2019/0353968 A1
(43) Pub. Date: Nov. 21, 2019

(54) ARRAY SUBSTRATE, DISPLAY PANEL AND DISPLAY DEVICE

(71) Applicants: BOE TECHNOLOGY GROUP CO., LTD., Beijing (CN); HEFEI BOE DISPLAY TECHNOLOGY CO., LTD., Hefei, Anhui (CN)

(72) Inventor: Ming HUA, Beijing (CN)

(73) Assignees: BOE Technology Group Co., Ltd., Beijing (CN); Hefei BOE Display Technology Co., Ltd., Hefei, Anhui (CN)

(21) Appl. No.: 15/777,720

(22) PCT Filed: Sep. 20, 2017
(86) PCT No.: PCT/CN2017/102443

§ 371 Date: May 21, 2018

(30) Foreign Application Priority Data
Mar. 29, 2017 (CN) 201710197026.3

(51) Int. Cl. G02F 1/1362; G02F 1/13

(52) U.S. Cl. CPC G02F 1/136259; G02F 2001/136263; G02F 1/1306

(57) ABSTRACT

Embodiments of the present disclosure provide an array substrate, a display panel, and a display device. The array substrate includes a substrate, a first signal line arranged on the substrate, a second signal line intersecting with the first signal line, and a first bridge having a first end portion and a second end portion. The first end portion is electrically connected to the second signal line at a first position of the second signal line, the second end portion is electrically connected to the second signal line at a second position of the second signal line, and the first position and the second position are respectively positioned at two sides of an intersection portion of the first signal line and the second signal line.

### CROSS REFERENCE TO RELATED APPLICATIONS

This patent application is a National Stage Entry of PCT/CN2017/102443 filed on Sep. 20, 2017, which claims the benefit and priority of Chinese Patent Application No. 201710197026.3 filed on Mar. 29, 2017, the disclosures of which are incorporated herein by reference in their entirety as a part of the present application.

### BACKGROUND

Embodiments of the present disclosure relate to the field of display technologies, and more particularly, to an array substrate, a display panel, and a display device.

A thin film transistor liquid crystal display (TFT-LCD) is one of widely used display equipment at present. A basic construction of the TFT-LCD generally includes a liquid crystal cell arranged between two parallel glass substrates. The lower glass substrate (also known as an array substrate) is provided with a thin film transistor (TFT) and a pixel electrode. The upper glass substrate (also known as a color filter substrate) is provided with a color block (including red (R), green (G), and blue (B)) and a common electrode, and under the lower glass substrate there is provided with a backlight unit. White light emitted from the backlight unit successively passes through the lower glass substrate, the liquid crystal layer and the upper glass substrate, and finally presents full color display and grayscale brightness.

The TFT-LCD display typically has a plurality of pixel cells including R, G, and B pixels. Each pixel cell is drove by a signal line to display an image. The signal line includes a gate signal line (scanning signal line) for transmitting a scanning signal and a data signal line for transmitting a data signal. The thin film transistor is connected to the gate signal line and the data signal line to control the data signal transmitted to a pixel electrode.

### BRIEF DESCRIPTION

An aspect of the present disclosure provides an array substrate, including a substrate, a first signal line arranged on the substrate, a second signal line intersecting with the first signal line, and a first bridge having a first end portion and a second end portion. The first end portion is electrically connected to the second signal line at a first position of the second signal line, the second end portion is electrically connected to the second signal line at a second position of the second signal line, and the first position and the second position are respectively positioned at two sides of an intersection portion of the first signal line and the second signal line.

In an example embodiment, the first signal line includes a gate signal line, the second signal line includes a data signal line, and the second signal line is electrically connected to a source electrode of a thin film transistor on the substrate via the first bridge.

In an example embodiment, the first bridge and the second signal line are on the same layer.

In an example embodiment, the second signal line is integrally formed with the first bridge.

In an example embodiment, the first bridge is U-shaped.

In an example embodiment, the array substrate further includes a repair line configured for repairing the second signal line. The repair line is arranged between two adjacent first signal lines along an extension direction of the second signal line, and a projection of the repair line on the substrate at least partially overlaps with that of the second signal line on the substrate.

In an example embodiment, the repair line and the first signal line are on the same layer.

In an example embodiment, the repair line and the first signal line are made from the same material.

In an example embodiment, the array substrate further includes a storage capacitance line arranged along an extension direction of the first signal line, and the storage capacitance line is electrically isolated from the repair line.

In an example embodiment, the storage capacitance line and the repair line are on the same layer and have a plurality of segments spaced by the repair line. A via is arranged at a position, of each of the segments of the storage capacitance line, adjacent to the repair line, so as to bridge the respective segments of the storage capacitance line across the repair line.

In an example embodiment, the via is filled with indium tin oxide.

Another aspect of the present disclosure provides a display panel, including any one of the array substrates set forth in embodiments of the present disclosure.

Still another aspect of the present disclosure further provides a display device, including any one of the display panels set forth in embodiments of the present disclosure.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure, in which

FIG. 1 schematically illustrates a planar structure of an array substrate;

FIG. 2 schematically illustrates a pattern design diagram of an array substrate;

FIG. 3 schematically illustrates a planar structural diagram of an array substrate according to an embodiment of the present disclosure;

FIG. 4A schematically illustrates a planar structural diagram of another example array substrate according to an embodiment of the present disclosure;

FIG. 4B schematically illustrates a sectional view along Line AA′ in FIG. 4A;

FIG. 4C schematically illustrates a sectional view along Line BB′ in FIG. 4A;

FIG. 5A schematically illustrates a planar structural diagram of another example array substrate according to the present disclosure;

FIG. 5B schematically illustrates a sectional view along Line AA′ in FIG. 5A;

FIG. 5C schematically illustrates a sectional view along Line BB′ in FIG. 5A;

FIG. 6 schematically illustrates a planar structural diagram of still another example array substrate according to the present disclosure;

FIG. 7 schematically illustrates an example block diagram of a display panel according to an embodiment of the present disclosure; and

FIG. 8 schematically illustrates an example block diagram of a display device according to an embodiment of the present disclosure.

Corresponding reference numerals indicate corresponding parts or features throughout the several views of the drawings.

### DETAILED DESCRIPTION

First, it is to be noted that as used herein and in the appended claims, the singular form of a word includes the plural, and vice versa, unless the context clearly dictates otherwise. Thus, the singular words are generally inclusive of the plurals of the respective terms. Similarly, the words “comprise”, “include” are to be interpreted inclusively rather than exclusively, unless such a construction is clearly prohibited from the context. Where used herein the term “examples” particularly when followed by a listing of terms is merely exemplary and illustrative, and should not be deemed to be exclusive or comprehensive.

Moreover, in the drawings, the thicknesses and regions of layers are exaggerated for clarity. It is to be understood that when a layer, region or component is referred to as being “on” another element, it can be directly on the other element or intervening elements may also be present. In contrast, when a certain component is referred to as being “directly on” another component, there are no intervening elements present. Moreover, to clearly illustrate the relative position relation among parts in the drawings, in the planar structural diagrams, those parts closely related to the present disclosure are displayed in the same plane surface, and the sectional views illustrate the hierarchical relation among these parts.

It is to be understood that in embodiments of the present disclosure, “a first part is arranged along an extension direction of a second part” refers to a fact that the first part is arranged along a direction parallel to or basically parallel to the length direction of the second part. That is, the included angle between the first part and the second part may be 0°, or the included angle between the first part and the second part may be smaller than a specific angle, for example, 10°, 15°, and so on, which may depend on process conditions.

Example embodiments will now be described more fully with reference to the accompanying drawings.

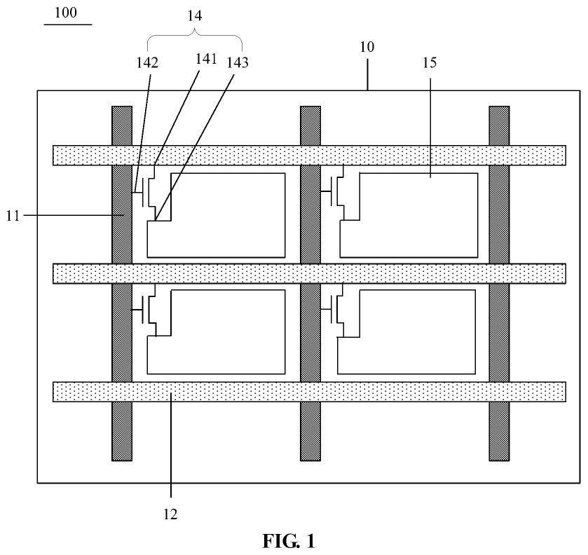

FIG. 1 schematically illustrates a planar structure of an array substrate 100, and FIG. 2 schematically illustrates a pattern design diagram of the array substrate 100. As shown in FIG. 1 and FIG. 2, the array substrate 100 may include a substrate 10, a gate signal line 11, a data signal line 12, a thin film transistor 14, and a pixel electrode 15. The data signal line 12 and the gate signal line 11 may be intersecting with each other and may be insulated from each other via an insulating layer. A source electrode 141 of the thin film transistor 14 is connected to the data signal line 12, a gate electrode 142 of the thin film transistor 14 is connected to the gate signal line 11, and a drain electrode 143 of the thin film transistor 14 is connected to the pixel electrode 15.

In this configuration as shown in FIG. 1 and FIG. 2, since the gate signal line 11 and the data signal line 12 intersect with each other, the data signal line 12 is prone to a defect at the intersection area of the gate signal line 11 and the data signal line 12. For example, the data signal line 12 may be fractured or short-circuited. In the case that the defective array substrate is applied to a display panel, an adverse effect may be caused to display, or even the display panel may be scrapped. In the case that the data signal line 12 has a defect at the intersection area, methods such as Laser Chemical Vapor Deposition (Laser CVD) may be employed to repair the data signal line 12. Specifically, in the case that the data signal line is fractured, a via may be formed in each film layer above the data signal line and at two ends of the fracture location, and then the fractured data signal line may be reconnected by depositing metal through the via using the Laser CVD method. However, in the case that this method is employed to repair the data signal line, on one hand the repair technologies are complex and the efficiency is thus low, and on the other hand, during metal is deposited, the metal is prone to diffusion, which may cause short circuit of other conducting elements around the data line.

According to an embodiment of the present disclosure, a first bridge is arranged at an intersection position of a first signal line (such as the gate signal line) and a second signal line (such as the data signal line). In the case that the second signal line is fractured at a position intersecting with the first signal line, a signal transmitted through the second signal line may continue to be transmitted thereon after bypassing the fracture position by virtue of the first bridge, without performing repair. In the case that the second signal line is short-circuited at the position intersecting with the first signal line, the short-circuit portion may be cut off, such that the signal transmitted through the second signal line may be continue to be transmitted thereon after bypassing the cut-off position by virtue of the first bridge, and thus the second signal line may be quickly repaired. Therefore, this configuration may avoid the adverse impact on the surrounding conductive parts caused by the deposition of metal wires using the Laser CVD method for repairing, and may improve the repairing efficiency and the success rate.

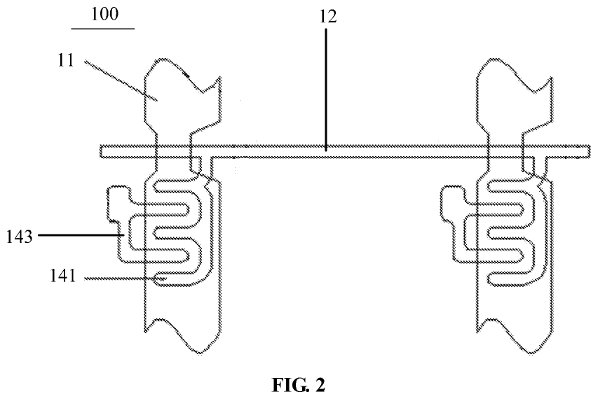

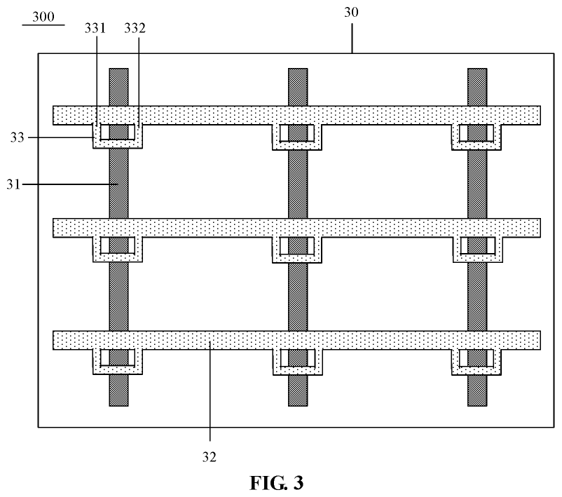

An embodiment set forth herein provides an array substrate, which may avoid a risk caused by using a Laser Chemical Vapor Deposition (CVD) method to repair a signal line. The example array substrate provided by the embodiment of the present disclosure will now be described in detail with reference to FIGS. 3-6.

FIG. 3 schematically illustrates a planar structural diagram of an array substrate 300 according to an embodiment of the present disclosure. As shown in FIG. 3, the array substrate 300 may include a substrate 30, a first signal line 31 arranged on the substrate 30, a second signal line 32 intersecting with the first signal line 31, and a first bridge 33 having a first end portion 331 and a second end portion 332. In this embodiment, the first end portion 331 may be electrically connected to the second signal line 32 at a first position of the second signal line 32, the second end portion 332 may be electrically connected to the second signal line 32 at a second position of the second signal line 32, and the first position and the second position are respectively positioned at two sides of an intersection portion of the first signal line 31 and the second signal line 32.

In this embodiment, the first signal line 31, the second signal line 32, and the first bridge 33 may be any signal line for transmitting a signal in the array substrate. As an example, the first signal line may be the gate signal line, and the second signal line may be the data signal line.

In the array substrate 300 provided by this embodiment, the first bridge 33, two ends of which are connected to the second signal line 32 respectively, is provided nearby the intersection position of the first signal line 31 and the second signal line 32. Therefore, in the case that the second signal line 32 is fractured at the position intersecting with the first signal line 31, the signal transmitted through the second signal line 32 may continue to be transmitted thereon after bypassing the fracture position by virtue of the first bridge 33. In the case that the second signal line 32 is short-circuited at the position intersecting with the first signal line 31, the short-circuit portion may be cut off, such that the signal transmitted through the second signal line 32 may continue to be transmitted thereon after bypassing the cut-off position by virtue of the first bridge 33. Therefore, the array substrate provided by the present disclosure does not affect further transmission of a signal in the event of fracture of the second signal line 32, and thus a special repair is not required. In the event of a short circuit, the second signal line 32 may be quickly repaired, and thus a repairing efficiency may be enhanced.

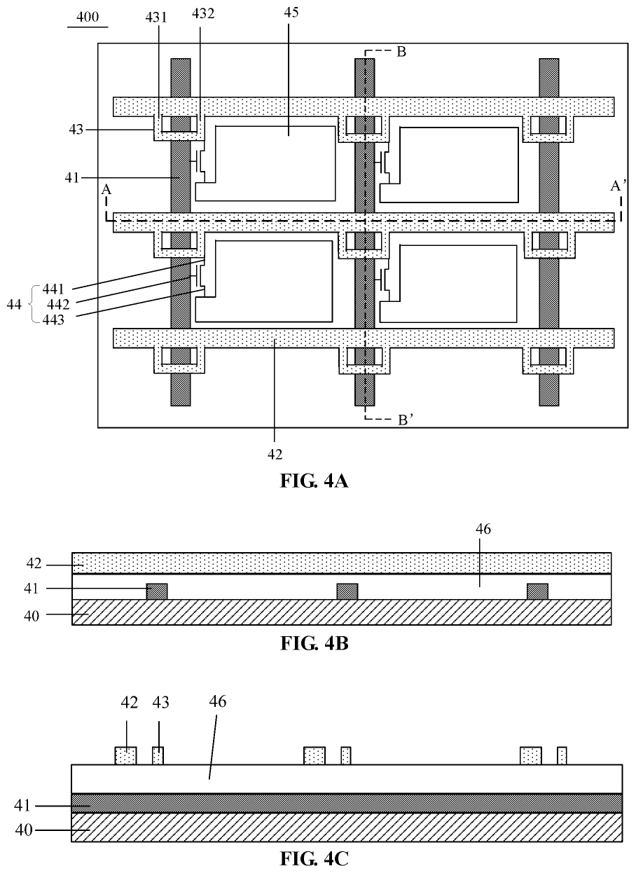

FIG. 4A schematically illustrates a planar structural diagram of another example array substrate 400 according to an embodiment of the present disclosure. In this example embodiment, as shown in FIG. 4A, the first signal line may be a gate signal line 41, which may be electrically connected to a gate electrode 442 of a thin film transistor 44 on the array substrate. The second signal line may be a data signal line 42, which may be electrically connected to a source electrode 441 of the thin film transistor 44 via a first bridge 43 having a first end portion 431 and a second end portion 432.

It should be understood that in an embodiment of the present disclosure, the array substrate also may have a pixel region defined by the gate signal line 41 and the data signal line 42 intersecting with each other. A pixel electrode 45 is provided in each region, and the pixel electrode 45 is electrically connected to a drain 443 of the thin film transistor.

FIG. 4B and FIG. 4C schematically illustrate sectional views along Line AA′ and Line BB′ in FIG. 4A respectively. In an example embodiment, the gate signal line 41 and the gate electrode 442 of the thin film transistor 44 may be formed in the same layer on the substrate 40. The data signal line 42, the first bridge 43, and the source electrode 441 and the drain electrode 443 of the thin film transistor may be formed in a layer above the gate signal line 41, and different layers or parts may be isolated by an insulating layer 46, as shown in FIG. 4B and FIG. 4C. In this embodiment, the data signal line 42 and the first bridge 43 may be integrally formed in the same layer. As thus, no additional fabricating process is required for fabricating the array substrate because the array substrate may be formed by way of one patterning process only by slightly changing the pattern shape of the data signal line, which may save the fabrication cost.

As shown in FIG. 4A, the first bridge may be designed to be a U-shaped pattern. In this embodiment, the source electrode may be connected to the bottom portion of the U-shaped pattern. It is to be understood that the first bridge also may have other geometrical shapes.

It is to be noted that although the width of the first bridges as shown in FIGS. 4A-4C are smaller than that of the first signal line and that of the second signal line, the width of the first bridge in the embodiment of the present disclosure is not limited thereto. The width of the first bridge also may be equal to or greater than that of the first signal line and that of the second signal line.

Moreover, in the drawings (particularly the sectional views) of the present disclosure, only layers or parts closely related to the inventive concept of the present disclosure are illustrated. However, it should be understood that the array substrate provided by embodiments of the present disclosure may further include other layers or parts required for actual operation. For example, an insulating layer may be further provided on the second signal line and the first bridge, such that other parts required for the array substrate may be formed above the layers where the second signal line and the first bridge are or the layers where the second signal line and the first bridge are may be planarized.

In the embodiment as shown in FIG. 4A, in the case that the data signal line 42 is fractured at the position intersecting with the gate signal line 41, the signal transmitted through the data signal line 42 may continue to be transmitted thereon after bypassing the fracture position by virtue of the first bridge 43, without performing repair. In the case that the data signal line 42 is short-circuited at the position intersecting with the gate signal line 41, the short-circuit portion may be cut off, such that the transmitted signal may continue to be transmitted thereon after bypassing the cut-off position by virtue of the first bridge 43, and thus the Laser CVD method is not applied for repairing the data signal line 42. Therefore, this configuration may avoid the adverse impact on the surrounding conductive parts caused by the deposition of metal wires using the Laser CVD method for repairing, and may improve the repairing efficiency and the success rate.

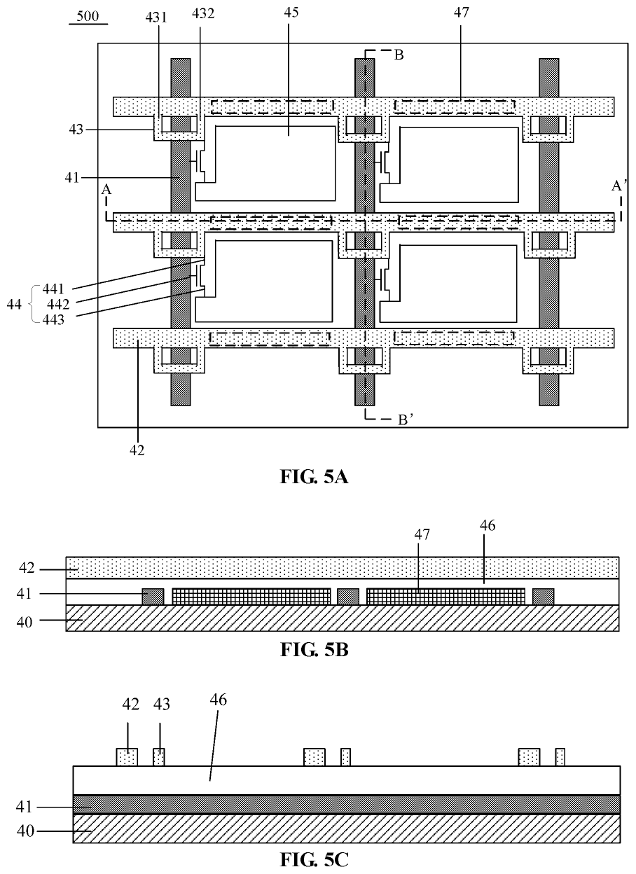

FIG. 5A schematically illustrates a planar structural diagram of another example array substrate 500 according to the present disclosure. FIG. 5B and FIG. 5C schematically illustrate sectional views along Line AA′ and Line BB′ in FIG. 5A respectively. In this example embodiment, as shown in FIG. 5A, FIG. 5B, and FIG. 5C, in addition to the elements as shown in FIG. 4A, the array substrate 500 may further include a repair line 47 for repairing the data signal line 42. The repair line 47 may be arranged between two adjacent gate signal lines 41 along an extension direction of the data signal line 42. Moreover, a projection of the repair line 47 on the substrate may at least partially overlap with that of the data signal line 42 on the substrate 40. In an example embodiment, the projection of the repair line 47 on the substrate may completely overlap with that of the data signal line 42 on the substrate. In FIG. 5A, to clearly illustrate the repair line 47, the width of the repair line 47 (shown by a dashed line in FIG. 5A) is drawn to be smaller than that of the data signal line. However, in actual operation, the width of the repair line may be equal to, slightly smaller than or slightly greater than that of the data signal line.

As shown in FIG. 5B, the repair line 47 and the gate signal line 41 may be formed in the same layer. The repair line 47 and the gate signal line 41 may be formed by the same material, for example, metallic material. As thus, no additional fabricating process is required for fabricating the array substrate because the array substrate may be formed by way of one patterning process, which may save the fabrication cost. It is to be understood that other embodiments also may be feasible. For example, the repair line and the gate signal line may be formed in different layers.

In this embodiment, in the case that a defect (for example, fracture or short circuit) occurs in a portion of the data signal line 42 between two adjacent gate signal lines 41, the data signal lines 42 at two ends of the defect position may be welded with the repair line 47, such that the data signal lines 42 are conductive by the repair line 47, thereby repairing the data signal lines. It is to be understood that in the case that the data signal line and other signal lines are short-circuited, the short-circuit portion may be cut off before the data signal line and the repair line are welded. Therefore, by this configuration in this embodiment, the adverse impact on the surrounding conductive parts caused by the deposition of metal wires using the Laser CVD method for repairing may be avoided, and the repairing efficiency and the success rate may be improved.

FIG. 6 schematically illustrates a planar structural diagram of still another example array substrate 600 according to the present disclosure. In this embodiment, as shown in FIG. 6, in addition to the elements as shown in FIG. 5A, the array substrate 600 may further include a storage capacitance line 48 arranged along an extension direction of the gate signal line 41. In this embodiment, the storage capacitance line 48 is electrically isolated from the repair line 47.

In an embodiment, the storage capacitance line 48 and the repair line 47 may be arranged in the same layer. To prevent a short circuit caused by an intersection of the storage capacitance line 48 and the repair line 47, the storage capacitance line 48 may be divided into a plurality of segments spaced by the repair line 47. That is, the storage capacitance line 48 is disconnected at the intersection position of the storage capacitance line 48 and the repair line 47, so as to be electrically isolated from the repair line. In this embodiment, a via 49 is arranged at a position, of each of the segments of the storage capacitance line 48, adjacent to the repair line, such that the respective segments of the storage capacitance line 48 is bridged through the via 49 across the repair line 47.

In an example embodiment, the respective segments of the storage capacitance line may be bridged by filling a conducting material into the vias. The deposited conducting material may include, for example, indium tin oxide.

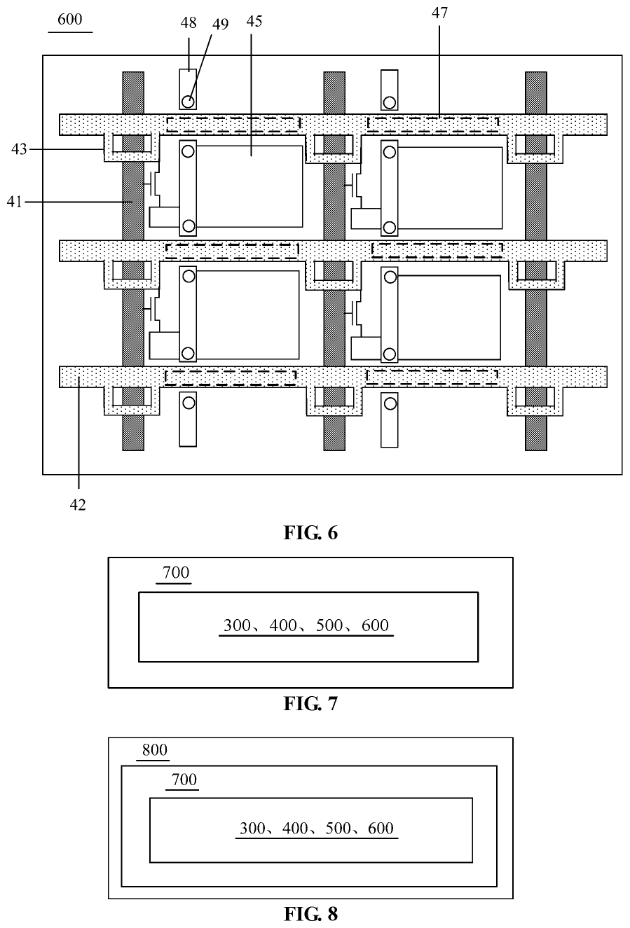

An embodiment set forth herein also provides a display panel. FIG. 7 schematically illustrates an example block diagram of a display panel 700 according to an embodiment of the present disclosure. As shown in FIG. 7, the display panel 700 may include the array substrate according to the present disclosure, such as any one of the array substrates 300, 400, 500, and 600 according to the embodiments described in FIGS. 3-6. Therefore, reference may be made to the embodiments of the array substrate of the present disclosure for the alternative embodiments of the display panel.

It is to be understood that the display panel 700 may further include a color filter substrate arranged opposite to the array substrate, a liquid crystal layer arranged between the color filter substrate and the array substrate, and other components required for the display panel in operation.

The display panel provided by embodiments of the present disclosure may be used in any product or part having a display function, such as a mobile phone, a tablet computer, a TV set, a notebook computer, a digital camera, or a navigation device and so on.

An embodiment set forth herein also provides a display device. FIG. 8 schematically illustrates an example block diagram of a display device 800 according to an embodiment of the present disclosure. As shown in FIG. 8, the display device 800 may include the display panel 700 according to the present disclosure. The display panel 700 may include the array substrate according to the present disclosure, such as any one of the array substrates 300, 400, 500, and 600 according to the embodiments described in FIGS. 3-6. It is to be understood that the display device 800 may further include other components such as a backlight or a light guide plate required for the display device in operation.

The foregoing description of the embodiment has been provided for purpose of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are included within the scope of the disclosure.

1. An array substrate comprising:
a substrate;
a first signal line arranged on the substrate;
a second signal line intersecting with the first signal line; and
a first bridge having a first end portion and a second end portion, wherein the first end portion is electrically connected to the second signal line at a first position of the second signal line, the second end portion is electrically connected to the second signal line at a second position of the second signal line, and the first position and the second position are respectively positioned at two sides of an intersection portion of the first signal line and the second signal line.

2. The array substrate according to claim 1, wherein the first signal line comprises a gate signal line, the second signal line comprises a data signal line, and the second signal line is electrically connected to a source electrode of a thin film transistor on the substrate via the first bridge.

3. The array substrate according to claim 1, wherein the first bridge and the second signal line are on a same layer.

4. The array substrate according to claim 3, wherein the second signal line is integrally formed with the first bridge.

5. The array substrate according to claim 1, wherein the first bridge is U-shaped.

6. The array substrate according to claim 1, further comprising a repair line configured for repairing the second signal line, wherein the repair line is arranged between two adjacent first signal lines along an extension direction of the second signal line, and a projection of the repair line on the substrate at least partially overlaps with that of the second signal line on the substrate.

7. The array substrate according to claim 6, wherein the repair line and the first signal line are on the same layer.

8. The array substrate according to claim 7, wherein the repair line and the first signal line are made from a same material.

9. The array substrate according to claim 6, further comprising a storage capacitance line arranged along an extension direction of the first signal line, wherein the storage capacitance line is electrically isolated from the repair line.

10. The array substrate according to claim 9, wherein the storage capacitance line and the repair line are on the same layer and have a plurality of segments spaced by the repair line, and wherein a via is arranged at a position, of each of the segments of the storage capacitance line, adjacent to the repair line, so as to bridge the respective segments of the storage capacitance line across the repair line.

11. The array substrate according to claim 9, wherein the via is filled with indium tin oxide.

12. A display panel comprising the array substrate according to claim 1.

13. A display device comprising the display panel according to claim 12.

14. The display panel according to claim 12, wherein the first signal line comprises a gate signal line, the second signal line comprises a data signal line, and the second signal line is electrically connected to a source electrode of a thin film transistor on the substrate via the first bridge.

15. The display panel according to claim 12, wherein the first bridge and the second signal line are on a same layer.

16. The display panel according to claim 12, further comprising a repair line configured for repairing the second signal line, wherein the repair line is arranged between two adjacent first signal lines along an extension direction of the second signal line, and a projection of the repair line on the substrate at least partially overlaps with that of the second signal line on the substrate.

17. The display panel according to claim 12, further comprising a storage capacitance line arranged along an extension direction of the first signal line, wherein the storage capacitance line is electrically isolated from the repair line.
